(19) United States
(12) Patent Application Publication
(10) Pub. No.: US 2024/0391712 A1
(43) Pub. Date: Nov. 28, 2024

(54) PLANAR DRIVE SYSTEM AND METHOD FOR OPERATING A PLANAR DRIVE SYSTEM

(71) Applicant: Beckhoff Automation GmbH, Verl (DE)

(72) Inventors: Lukas Bentfeld, Delbrück (DE); Johannes Beckhoff, Schloß Holte-Stukenbrock (DE); Felix Schulte, Rietberg (DE); Uwe Prüssmeier, Lemgo (DE); Keir Maguire, North Vancouver (CA)

(21) Appl. No.: 18/792,681

(22) Filed: Aug. 2, 2024

Related U.S. Application Data
(63) Continuation of application No. PCT/EP2023/053348, filed on Feb. 10, 2023.

(30) Foreign Application Priority Data
Feb. 11, 2022 (DE) 10 2022 103 261.2

(51) Int. Cl. B65G 54/02; B65G 43/00

(52) U.S. Cl. CPC B65G 54/02; B65G 43/00

(57) ABSTRACT

The invention relates to a planar drive system comprising at least a stator assembly with a plurality of coil groups for generating a stator magnetic field, a stator surface above the stator assembly, and a rotor. The rotor comprises a plurality of magnet assemblies for generating a rotor magnetic field. In a first operating state, the rotor can be moved above the stator surface in parallel to the stator surface with the aid of an interaction of the stator magnetic field with the rotor magnetic field. In a second operating state, the rotor is at least restricted in its ability to move in parallel to and perpendicularly with regard to the stator surface by a safety system.

### CROSS-REFERENCE TO RELATED APPLICATIONS

This patent application is a continuation of International Patent Application No. PCT/EP2023/053348, entitled “Planar Drive System and Method for Operating a Planar Drive System” filed 10 Feb. 2023, which claims the priority of German patent application DE 10 2022 103 261.2, entitled “Planarantriebssystem und Verfahren zum Betreiben eines Planarantriebssystems,” filed 11 Feb. 2022, each of which is incorporated by reference herein, in the entirety and for all purposes.

### FIELD

The invention relates to a planar drivglee system and a method for operating a planar drive system.

### BACKGROUND

Planar drive systems may be used in automation technology, in particular in production technology, handling technology and process engineering. Planar drive systems may be used to move or position a moving element of a system or machine in at least two linearly independent directions. Planar drive systems may comprise a permanently energized electromagnetic planar motor with a planar stator and a rotor that may move on the stator in at least two directions.

In a permanently energized electromagnetic planar motor, a drive force is exerted upon the rotor by the fact that energized coil groups of a stator assembly interact magnetically with drive magnets of a plurality of magnet arrangements of the rotor. Planar drive systems with rectangular and longitudinally elongated coil groups and rectangular and longitudinally elongated magnet arrangements of the rotor are known from the state of the art. Such a planar drive system is described, for example, in disclosure document DE 10 2017 131 304 A1. With the aid such a planar drive system, particularly a linear and translatory movement of the rotor is allowed for. This means that with the aid of such a planar drive system, the rotor may be moved freely in parallel to the stator surface above a stator surface below which the rectangular and elongated coil groups are arranged, and perpendicularly with regard to the stator surface at least at different distances from the stator surface.

If such a planar drive system is used in automation technology, in particular in manufacturing technology, handling technology and process engineering, it may be required to fulfill specified safety mechanisms, for example to protect human operators of the planar drive system from accidents and thus from injury, or to protect components of the planar drive system from defects or destruction in the event of malfunctions or a system failure, for example a power failure. Such protective mechanisms have not yet been described. It may also be necessary to protect objects moved by the planar drive system. No corresponding protective mechanism is currently known for this either.

### SUMMARY

It is an object of the invention to provide an improved planar drive system. A further object of the invention is to provide an operating system or a method for operating such a planar drive system.

These objects are solved by the planar drive system and the method for operating a planar drive system of the independent patent claims. Advantageous further embodiments are indicated in dependent patent claims.

A planar drive system comprises at least a stator assembly having a plurality of coil groups for generating a stator magnetic field, a stator surface above the stator assembly and a rotor. The stator assembly comprising the coil groups may be arranged in a stator module. The rotor comprises a plurality of magnet assemblies for generating a rotor magnetic field. In a first operating state, the rotor may be moved above the stator surface in parallel to the stator surface with the aid of an interaction of the stator magnetic field with the rotor magnetic field. In a second operating state, the rotor is at least restricted in terms of its mobility in parallel to the stator surface by a safety system, wherein the rotor is also at least restricted perpendicularly with regard to the stator surface in terms of its mobility by the safety system in the second operating state.

The safety system therefore serves to restrict the movement of the rotor in the second operating state both in parallel to the stator surface and perpendicularly with regard to the stator surface. This may be used, for example, to protect human operators of the planar drive system from accidents and thus from injury. Furthermore, it may be achieved that objects moved by the planar drive system are protected.

The first operating state may comprise free movement of the rotor or, if necessary, of a plurality of rotors, while the second operating state comprises securing at least one rotor, with the rotor being secured by the fact that its mobility is at least restricted.

### EXAMPLES

In an embodiment of the planar drive system, the safety system comprises a passive safety device. The passive safety device restricts the movement of the rotor. The term passive safety device is understood to mean a safety device without moving parts. This means that the rotor's mobility is restricted not by moving parts, but by permanently installed elements.

In an embodiment of the planar drive system, the passive safety device makes it more difficult to remove the rotor from the stator surface in the event that the current supply in the coil groups fails. It may be provided that the removal of the rotor from the stator surface is completely prevented. This is particularly advantageous if the planar drive system comprises an installation position in which the stator surface is not arranged horizontally or in which the stator surface is arranged horizontally but the rotor is arranged below the stator surface with regard to earth's center. In these cases, if the current supply fails, the rotor could move away from the stator surface in an uncontrolled manner and endanger people. Furthermore, uncontrolled removal of the rotor from the stator surface could damage objects transported by the rotor. The passive safety device may be used to reduce or even completely prevent the risk of endangering a person or damaging an object.

In an embodiment of the planar drive system, the passive safety device comprises a fastening. The fastening may be used in particular for planar drive systems having a non-horizontal stator surface.

In an embodiment of the planar drive system, a first strip is arranged on the rotor and a second strip on the stator surface. It is possible for the first strip to comprise a hook tape and the second strip a loop tape or vice versa. It is also possible to use a velour tape instead of the loop tape. Alternatively, the hook tape may be replaced by a mushroom tape. In an embodiment, both the first strip and the second strip comprise a mushroom tape.

In the embodiments of the passive safety device with strips, a failure of the current supply to the coil groups may particularly lead to the rotor dropping onto the stator surface, as the interaction between the stator magnetic field and the rotor magnetic field is eliminated. The rotor and the stator surface are then connected to each other by the first strip and the second strip, so that uncontrolled removal of the rotor from the stator surface may be avoided. This may be particularly advantageous if the stator surface is not horizontal and static friction between the rotor and the stator surface would not be sufficient to counteract a downward force of the rotor, so that the rotor would slide downwards along the stator surface.

In an embodiment of the planar drive system, the passive safety device comprises a double rail arranged above the stator surface. A double rail is a device having two individual contact surfaces. An object holder of the rotor may be guided between the contact surfaces of the double rails. The double rail may then, for example, hold the rotor in place when an object is to be removed from the rotor and thus prevent the rotor from being removed from the planar drive system, as the double rail may prevent the rotor from moving away from the stator surface.

In an embodiment, the planar drive system is arranged in such a way that in the event that the current supply in the coil groups fails, the rotor moves away from the stator surface due to gravity, wherein the rotor may be caught with the aid of the double rail. This may be the case, for example, if the stator surface is arranged horizontally and the rotor is arranged below the stator surface in relation to the center of the earth. Such an arrangement may also be referred to as an upside-down arrangement.

In an embodiment of the planar drive system, the safety system comprises an active safety device, wherein the active safety device restricts the movement of the rotor. The term active safety device is understood to mean a safety device in which a controlled securing of the rotor is possible, for example with moving parts or with the aid of a special energization of the coil groups. The restriction of the rotor's mobility is therefore controlled.

In an embodiment of the planar drive system, the active safety device comprises a controller, wherein the controller is set up to evaluate operating parameters relevant to operational safety and to transfer the planar drive system to the second operating state if an evaluation of the relevant operating parameters indicates that unsafe operation could be present. The evaluation of the relevant operating parameters may include, for example, monitoring whether a current supply is available.

In an embodiment of the planar drive system, the active safety device comprises an uninterrupted current supply. This means, for example, that the planar drive system may continue to operate even if the current supply fails, at least until all rotors have been transferred to a safe operating state.

In an embodiment of the planar drive system, the active safety device comprises a retaining element. In the second operating state, the rotor is guided to the retaining element in such a way that the rotor is restricted in its movement by the retaining element. In particular, this may be combined with the uninterrupted current supply and the rotor may first be moved to the retaining element and then fixed there with the aid of the retaining element. No further current supply to the coil groups is now required to hold the rotor on the planar drive system and, if necessary, the current supply to the coil groups may now be switched off in a controlled manner when all rotors are secured.

In an embodiment of the planar drive system, the active safety device comprises a first movable barrier between a first region of the stator surface and a second region of the stator surface. Once the first movable barrier is closed, the rotor may no longer be moved from the first region to the second region. The first movable barrier may, for example, comprise a door that may be lowered onto the stator surface.

In an embodiment of the planar drive system, the active safety device comprises a second movable barrier between the first region and an edge of the planar drive system. The second movable barrier may only be opened when the first movable barrier is closed. This e.g. allows for an intervention by an operator of the planar drive system only when the rotor is located in the first region secured by the first movable barrier and the first movable barrier is closed, so that further rotors from the second region cannot enter the first region, thus reducing or avoiding danger to the operator during the operator's intervention. The intervention of the operator may, for example, involve loading and/or unloading the rotor.

In an embodiment of the planar drive system, the second movable barrier may only be opened when the current to drive coils of the stator assemblies in the first region is switched off. This allows for a further improvement in safety, as rotors in the first region cannot be moved any further.

In an embodiment of the planar drive system, the first movable barrier comprises a hold-down device, wherein the hold-down device fixes the rotor on the stator surface when the first barrier is closed. This allows for a further improvement in safety, as movement of the rotor is made even more difficult.

In an embodiment of the planar drive system, the active safety device comprises a third movable barrier with a double rail. This may be controlled and restrict the movement of the rotor so that safety may be further increased.

In an embodiment of the planar drive system, the active safety device comprises a fluid chamber arranged below the stator surface. The fluid chamber may be filled with a ferrofluid, wherein when the fluid chamber is filled with the ferrofluid, the rotor is restricted in terms of its ability to move in parallel to and perpendicularly with regard to the stator surface due to a magnetic interaction of the ferrofluid with the magnet assemblies. The ferrofluid may contain iron atoms, for example. The fluid chamber may be embodied as a cavity, container, tank, pipe system or flooding chamber.

In an embodiment of the planar drive system, a controller is set up to control the active safety device. An operating method for the planar drive system may then include controlling the active safety device.

In an embodiment of the planar drive system, a planar drive system controller is set up to control a current supply to the coil groups of the stator assemblies and to detect that the planar drive system is in the second operating state. The planar drive system controller is also set up to energize the coil groups of the stator assemblies in such a way that the planar drive system is transferred from the second operating state to the first operating state. The controller and the planar drive system controller may be embodied as a common controller.

A method for operating a planar drive system involves the controller and/or the planar drive system controller energizing the coil groups of the stator assemblies and/or controlling the active safety device in such a way that the planar drive system is transferred from the second operating state to the first operating state.

### BRIEF DESCRIPTION OF THE DRAWINGS

The invention is described in more detail with reference to the attached figures, in which:

FIG. 1 is an isometric view of a planar drive system;

FIG. 2 is a side view of the planar drive system of FIG. 1;

FIG. 3 shows a side view of a planar drive system;

FIG. 4 shows side view of a planar drive system;

FIG. 5 is a plan view from below the planar drive system of FIG. 4;

FIG. 6 depicts a side view of a planar drive system;

FIG. 7 is a top view of a planar drive system;

FIG. 8 is a side view of a planar drive system;

FIG. 9 shows a side view of the planar drive system of FIG. 8;

FIG. 10 is a side view of a planar drive system;

FIG. 11 is a side view of a planar drive system;

FIG. 12 depicts a side view of a planar drive system;

FIG. 13 shows a side view of a planar drive system;

FIG. 14 is a further side view of the planar drive system of FIG. 13;

FIG. 15 shows a side view of a planar drive system;

FIG. 16 shows a side view of a planar drive system;

FIG. 17 is a side view of a planar drive system; and

FIG. 18 shows a flow chart of an operating method.

### DETAILED DESCRIPTION

In the following, the same reference numerals may be used for identical features. Furthermore, for reasons of clarity, it may be provided that not all elements are shown in every figure. Furthermore, for the sake of clarity, it may be provided that not every element is provided with its own reference numeral in every drawing.

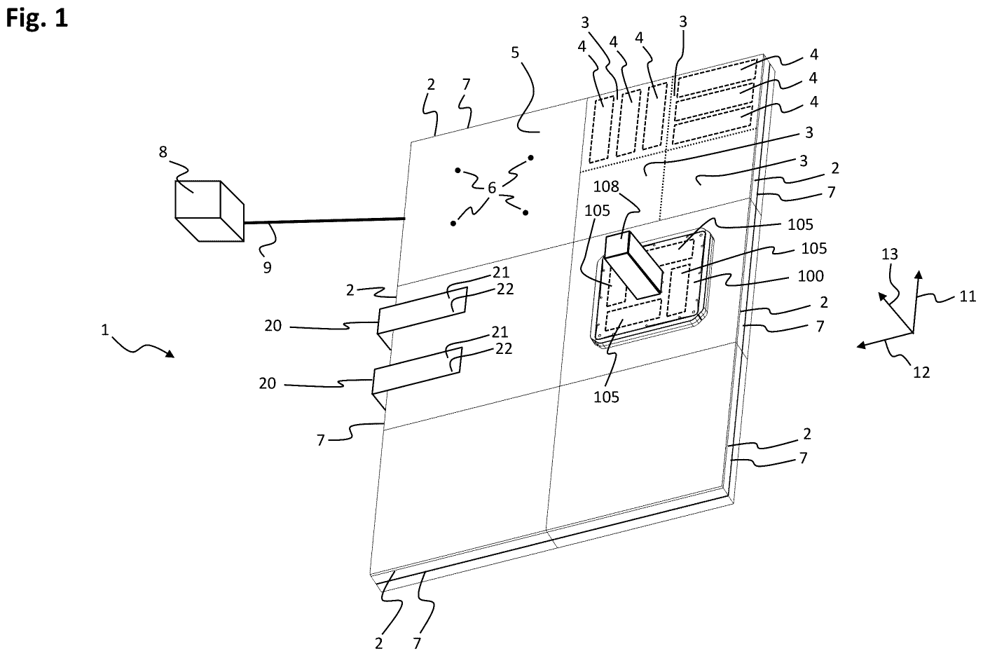

FIG. 1 shows a planar drive system 1 having six stator modules 2, wherein the stator modules 2 are arranged in such a way that a rectangle is in the form of two by three stator modules 2. Other arrangements of the stator modules 2 are conceivable, as well; more or fewer than six stator modules 2 may also be arranged. In the stator module 2 shown on above on the right-hand side, an interior of the stator module 2 is indicated, wherein the stator module 2 comprises four stator assemblies 3, the four stator assemblies 3 being arranged within a stator module 2 in a square two-by-two arrangement.

Furthermore, it is shown for two stator assemblies 3 that the stator assemblies 3 comprise coil arrangements 4, wherein the coil arrangements 4 are shown with different orientations. The coil arrangements 4 are used to generate a stator magnetic field. In the embodiment shown, the coil arrangements 4 are embodied as rectangular and elongated coil arrangements 4. Three individual, rectangular and elongated coils of a coil arrangement 4 are shown in each stator assembly 3 of the stator modules 2. Similarly, in an embodiment, a different number of individual rectangular and elongated coils could form a coil arrangement 4. In this case, their longitudinal extension is oriented in parallel with regard to one of the edges of the respective stator assembly 2.

Below each of the coil arrangements 4 shown, further coils are provided which have an orientation rotated by 90° with respect to their longitudinal extension. This grid of elongated and rectangular coils of a coil arrangement 4 may be embodied several times on top of each other. In reality, neither stator assemblies 3 nor coil arrangements 4 are visible, as they are surrounded by a stator module housing 7 of the stator module 2. The six stator modules 2 form a continuous stator surface 5 above the stator assemblies 3. Furthermore, a rotor 100 is arranged, wherein the rotor comprises a plurality of magnet assemblies 105 for generating a rotor magnetic field. The coil arrangements 4 may interact with the magnet assemblies 105 when energized accordingly, thereby moving the rotor 100 within the planar drive system 1 above the stator surface 5. A plane of movement for the rotor 100 is thus defined by the stator surface 5.

The depiction in FIG. 1 is simplified, as a plurality of coil arrangements 4 are arranged in each stator assembly 3, each of which is arranged at a 90° angle with regard to one another, but only one position of coil arrangements 4 is shown in each case. The magnet assemblies 105 are arranged to rotate within the rotor 100 and may each interact with the coil arrangements 4 in order to move the rotor 100. In particular, the movements of the rotor may take place in a plane parallel with regard to the stator surface 5, which is defined by a first direction 11 and a second direction 12. It is also possible to superimpose these movements so that the rotor 100 may be moved in all directions parallel with regard to the stator surface 5. The arrangement of four stator assemblies 3 within a stator module 2 corresponds to the stator modules 2 for a planar drive system 1 sold by the applicant under the name XPlanar. Alternatively, it is also possible to arrange more or fewer stator assemblies 3 within a stator module 2. For example, each stator module 2 may comprise only one stator assembly 3 or may comprise more than four stator assemblies 3.

Also shown in FIG. 1 is a planar drive system controller 8, which is connected to one of the stator modules 2 with the aid of a data line 9. It may be provided that the stator modules 2 may transmit communication signals to one another. Alternatively, each stator module 2 may also be connected to the planar drive system controller 8. The planar drive system controller 8 is set up to output control commands to the stator modules 2, wherein the stator modules 2 are set up to energize the coil arrangements 4 on the basis of the control signals and thereby control a movement of the rotor 100 in parallel with regard to the stator surface 5. The coil arrangements 4 may also be energized in such a way that the rotor 100 is moved perpendicularly with regard to the stator surface 5 in a third direction 13. In addition, the coil arrangements 4 may also be energized in such a way that the rotor 100 rotates about a rotational axis perpendicular to the stator surface 5 or is tilted about a tilting axis parallel with regard to the stator surface 5.

Also shown in FIG. 1 are magnetic field sensors 6 in one of the stator modules 2, wherein the other stator modules 2 may also have magnetic field sensors 6. Using the magnetic field sensors 6, a position of the rotor 100 may be determined and passed on to the planar drive system controller 8. The magnetic field sensors 6 may, for example, be embodied as Hall sensors, in particular as 3D Hall sensors. Alternatively, raw data from the magnetic field sensors 6 may also be passed on to the planar drive system controller 8 and a position of the rotor 100 may be determined by the planar drive system controller 8.

The planar drive system 1 shown in FIG. 1 may be used in automation technology, in particular production technology, handling technology and process engineering, to transport objects. The objects may be arranged on the rotor 100, for example. For this purpose, the rotor 100 comprises an object holder 108.

The planar drive system 1 also comprises a safety system 20. In a first operating state, the rotor 100 may be moved above the stator surface 5 in parallel to the stator surface 5 with the aid of an interaction of the stator magnetic field with the rotor magnetic field. In a second operating state, the rotor 100 is restricted at least in its movement parallel with regard to the stator surface 5 and perpendicularly with regard to the stator surface 5 by the safety system 20. In this embodiment example, the safety system 20 is embodied as a passive safety device 21 and comprises a double rail 22 arranged above the stator surface 5. The passive safety device 21 is attached to one of the stator modules 2. The double rail 22 is embodied in such a way that the object holder 108 of the rotor 100 may be guided between the double rail 22 and the rotor 100 is then arranged below the double rail 22.

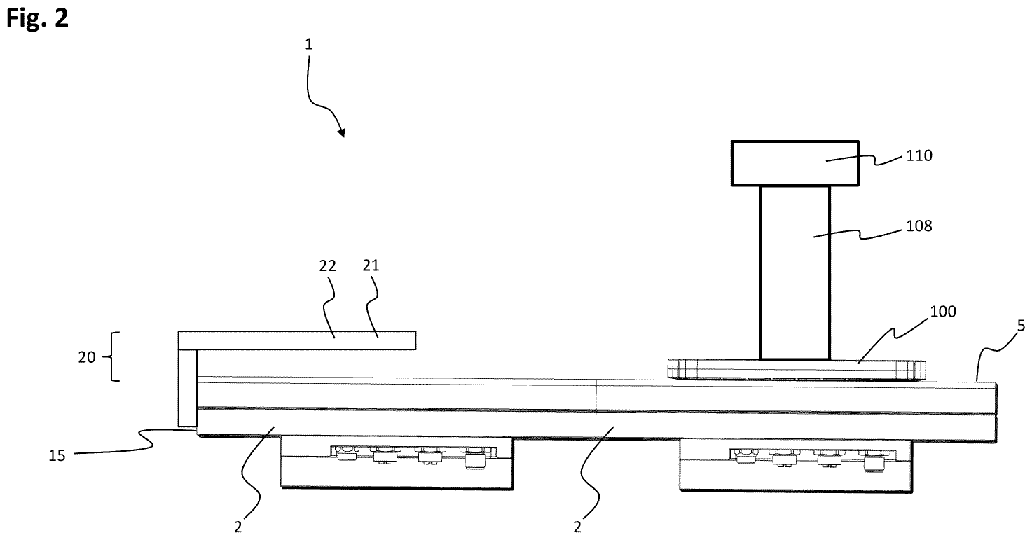

FIG. 2 shows a side view of the planar drive system 1 of FIG. 1. An object 110 is also shown, which is arranged on the object holder 108 of the rotor 100. In the first operating state, the rotor 100 may be moved above the stator surface 5, but not in the area of the passive safety device 21 or double rail 22. Thus, in the first operating state, the rotor 100 is not restricted in its movement by the passive safety device 21 or double rail 22. If the object 110 is to be removed from the rotor 100 or placed onto the rotor 100, the planar drive system may be transferred to the second operating state. In order to do this, the rotor 100 is moved below the double rail 22.

The object 110 is arranged on a side of the double rail 22 opposite to the rotor 100. A distance of the double rail 22 is dimensioned in such a way that object holder 108 may be arranged in this area. The rotor 100 is arranged between the stator surface 5 and the double rail 22. As a result, when the object 110 is removed to the left or upwards in the event that the object 110 cannot be released from the object holder 108, the rotor 100 is held back by the double rail 22 and cannot be unintentionally removed from the planar drive system 1. As a result, an operator of the planar drive system 1 cannot unintentionally remove the rotor 100 from the planar drive system 1. This removal protection may ensure that operators cannot be injured by the magnet assemblies 105 of the rotor 100 and that, for example, crushing between the rotor 100 and other objects, in particular consisting of steel, is prevented. The same also applies in the event that the object 110 is to be removed mechanically. This allows for an increase in safety.

The object holder 108 may be embodied to be flexible, i.e. bendable. This may make it possible for an operator who guides a hand into the path of movement of the rotor not to suffer any damage from the impact of the rotor 100, the object holder 108 or the object 110.

The passive safety device 21 may be arranged at an edge 15 of the planar drive system 1. Furthermore, it may be provided that the passive safety device 21 includes more than one double rail 22, wherein the double rails 22 may be constructed as explained in connection with FIGS. 1 and 2 and wherein a plurality of rotors 100 may then be loaded and unloaded simultaneously.

The other figures may contain the reference numerals explained in connection with FIGS. 1 and 2. In the further description, these reference numerals will not be referred to any further, as the parts of the planar drive system 1 described with these reference numerals have been described in connection with FIGS. 1 and 2.

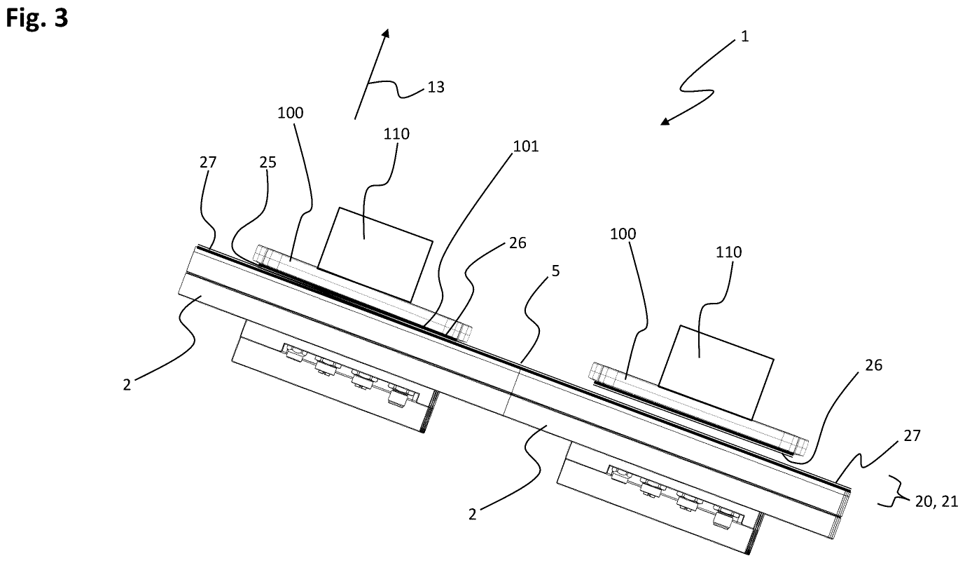

FIG. 3 shows a side view of a planar drive system 1, in which a safety system 20 in the form of a passive safety device 21 is additionally provided. Two stator modules 2 are shown, wherein the stator modules 2 are arranged in such a way that the stator surface 5 is not arranged horizontally, but at an angle. A rotor 100 is arranged above each stator module 2. If the electrical supply for the entire planar drive system 1 or for one of the stator modules 2 was to fail, the rotors 100 could possibly slide down along the stator surface 5 and pose a danger to an operator or a transported object 110.

FIG. 3 shows that the electrical supply for the left-hand stator module 2 has failed and as a result, it is not possible to energize the coil groups 4 of this stator module 2. The rotor 100 arranged above it has therefore moved in the direction of the stator module 2. The passive safety device 21 comprises a VELCRO fastening 25 between the stator surface 5 and the rotor 100. For this purpose, the rotor 100 comprises a first VELCRO strip 26 and the stator surface 5 has a second VELCRO strip 27. The fastening 25 embodied between the first strip 26 and the second strip 27 thus prevents or at least makes it more difficult for the rotor 100 to slip off. It may be provided that the first strip 26 comprises a hook tape and the second strip 27 comprises a loop tape.

Furthermore, the first strip 26 may also comprise a loop tape and the second strip 27 a hook tape. Furthermore, a velour tape for the first strip 26 or for the second strip 27 is also possible instead of the fleece tape. Alternatively, the hook tape may be replaced by a mushroom tape. In an embodiment, both the first strip 26 and the second strip 27 comprise a mushroom tape. In particular, the first strip 26 may be arranged over a large area on an underside 101 of the rotor 100 and cover a large part (more than 75 percent) of the underside 101 or the entire underside 101. The second strip 27 may in particular be arranged over a large area on the stator surface 5 and cover a large part (more than 75 percent) of the stator surface 5 or the entire stator surface 5. Furthermore, it may be provided that the second strip 27 is only arranged in inclined areas of the stator surface 5.

In the second operating state, the rotor 100 is therefore attached to the stator surface 5 with the aid of the fastening 25. However, in the illustration in FIG. 3, this only applies to one of the two rotors 100, as the other rotor 100 does not rest on the stator surface 5. This may particularly be the case if it is not possible to energize the coil groups 4 for only one stator module 2. The rotor 100 not resting on the stator surface 5 is then still in the first operating state and may be moved above the stator surface 5.

In order to detach the rotor 100 from the stator surface 5 again when the coil groups 4 may be energized again, it may be provided that the coil groups 4 are energized in such a way that the rotor 100 is moved away from the stator surface 5 due to an interaction of the rotor magnetic field and the stator magnetic field. To support this, it may also be provided to rotate the rotor 100 about an axis parallel to the third direction 13 at a predetermined angle, as this makes it easier to release the fastening 25. It may also be provided that after the planar drive system 1 or the stator module 2 has restarted, the magnetic field sensors 6 are used to determine the positions at which the rotor 100 is arranged on the stator surface 5 with the aid of the fastening 25. The current supply to the coil groups 4 may be controlled by the planar drive system controller 8.

As an alternative to the illustration in FIG. 3, instead of the first strip 26 and the second strip 27, an anti-slip mat, for example made of rubber or sponge rubber, may be arranged on the rotor 100 and/or on the stator surface 5, as well, wherein this may also prevent the rotor 100 from slipping.

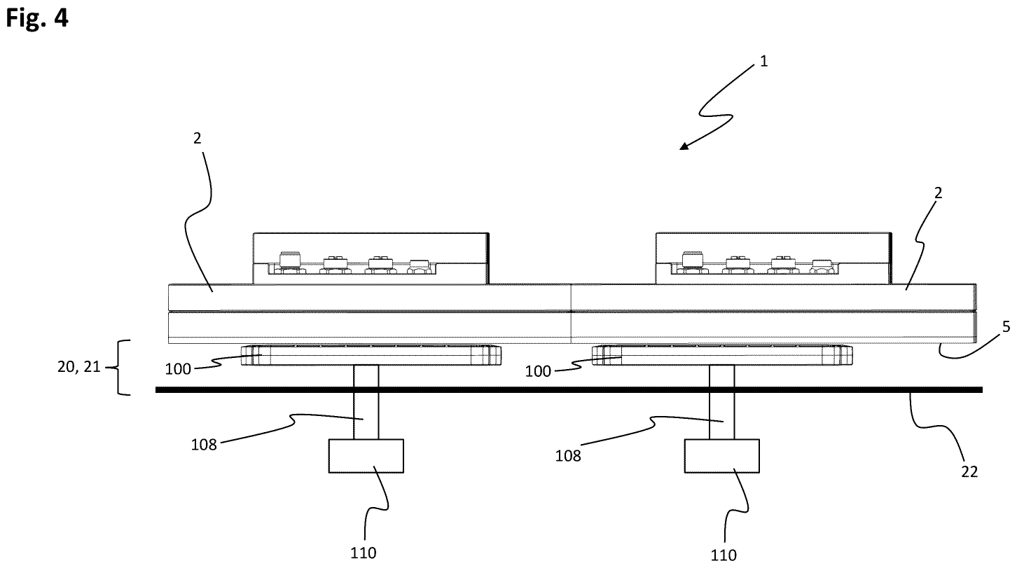

FIG. 4 shows a side view of a planar drive system 1, which also comprises a safety system 20 in the form of a passive safety device 21. The passive safety device 21 makes it more difficult for the rotor 100 to move away from the stator surface 5 in the event that a current supply to the coil groups 4 fails. The planar drive system 1 comprises an installation position in which the stator surface 5 is arranged horizontally, but the rotors 100 are arranged below the stator surface 5 in relation to the earth's center. In the event that the current supply fails, the rotors 100 would therefore move away from the stator surface 5 in an uncontrolled manner and could endanger people and also the objects 110 attached to the rotors 100 via object holders 108. With the aid of the passive safety device 21, the risk of endangering a person or damaging an object 110 may be reduced or even completely prevented.

The passive safety device 21 is embodied in the form of a double rail 22, wherein the object holders 108 are each guided in spaces between the double rail 22 in such a way that the rotor 100 may only be moved as far as the double rail 22 and not beyond. Here too, the objects 110 and the rotors 100 are each arranged on opposite sides of the double rails 22. The rotors 100 are arranged between the stator surface 5 and the double rail 22.

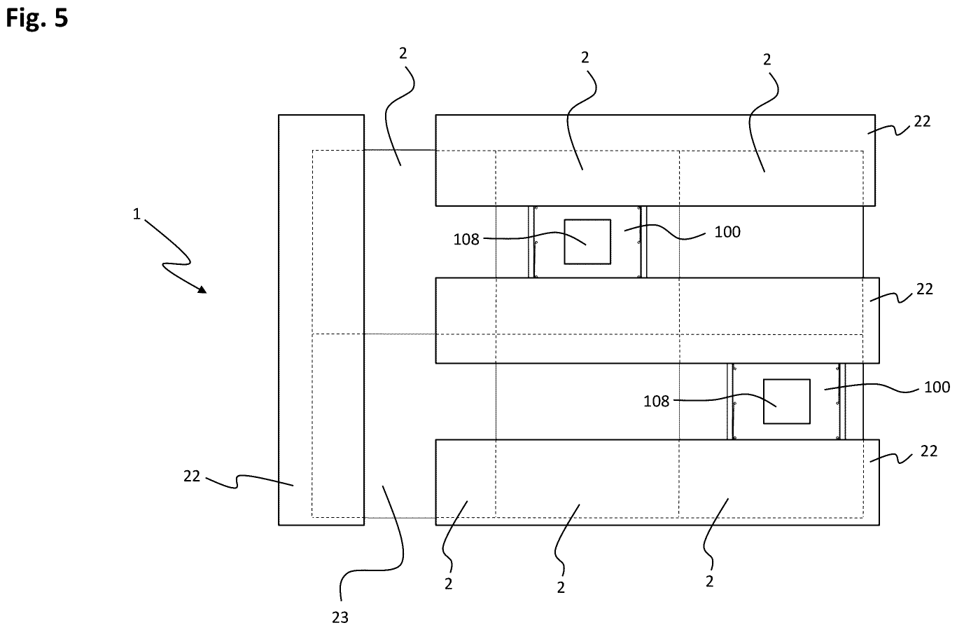

FIG. 5 shows a plan view from below on a planar drive system 1, which is embodied as described in connection with FIG. 4. For the sake of clarity, the objects 110 have been omitted so that it is clear that the object holders 108 are arranged in the spaces 23 between the double rails 22. The spaces 23 form travel paths for the rotors 100. The rotors 100 are therefore no longer freely movable over the stator surface 5, but the arrangement of the double rails 22 or spaces 23 must be taken into account when planning the movement trajectories of the rotors 100.

If a current supply to one or to a plurality of stator modules 2 fails, the rotor 100 or possibly also a plurality of or all rotors 100 move away from the stator surface 5 due to gravity and are caught by the double rail 22. The planar drive system 1 is then in the second operating state, in that movement of the rotor 100 away from the stator surface 5 is prevented by the double rail 22 and movement of the rotor 100 parallel to the stator surface 5 is at least impeded by the double rail 22 due to friction between the rotor 100 and the double rail 23. Friction elements such as a layer of rubber may also be applied to the double rails 22 in order to increase the friction accordingly.

The planar drive system 1 of FIGS. 4 and 5 is thus arranged in such a way that, in the event that a current supply in the coil groups 4 fails, the rotor 100 may be removed from the stator surface 5 due to gravity and caught with the aid of the double rail 22. If a current supply is now available again, the planar drive system 1 may be returned to the first operating state. For this purpose, the magnetic field sensors 6 may be used to determine the positions of the rotors 100 and initially energize the coil groups 4 in such a way that the rotors 100 are attracted away from the double rail 22 and towards the stator surface 5. As soon as the rotors 100 are arranged above the double rail 22 again, the rotors 100 may also be moved parallel to the stator surface 5. This process may be controlled by the planar drive system controller 8.

A distance between the stator surface 5 and the double rail 22 may be selected in such a way that the magnet assemblies 105 move a maximum of 5 millimeters away from the stator surface 5 when the rotor 100 rests on the double rail 5. In this case, the magnet assemblies 105 are still within the magnetic influence range of the coil groups 4. For example, a distance of the double rail 22 from the stator surface may be a sum of the aforementioned 5 millimeters and a thickness of the rotor 100, which is, for example, between 10 and 15 millimeters. The distance of the double rail 22 from the stator surface 5 may then be in the range between 11 millimeters and 20 millimeters, for example 14 millimeters for rotors 100 having a thickness of 12 millimeters.

The safety systems 20 shown in FIGS. 1 to 5 comprise passive safety devices 21, which means in particular that they do not have any moving parts. The restriction of the rotor 100 in its mobility is therefore achieved without moving parts, but by permanently installed elements such as the double rails 22 and the fastenings 25.

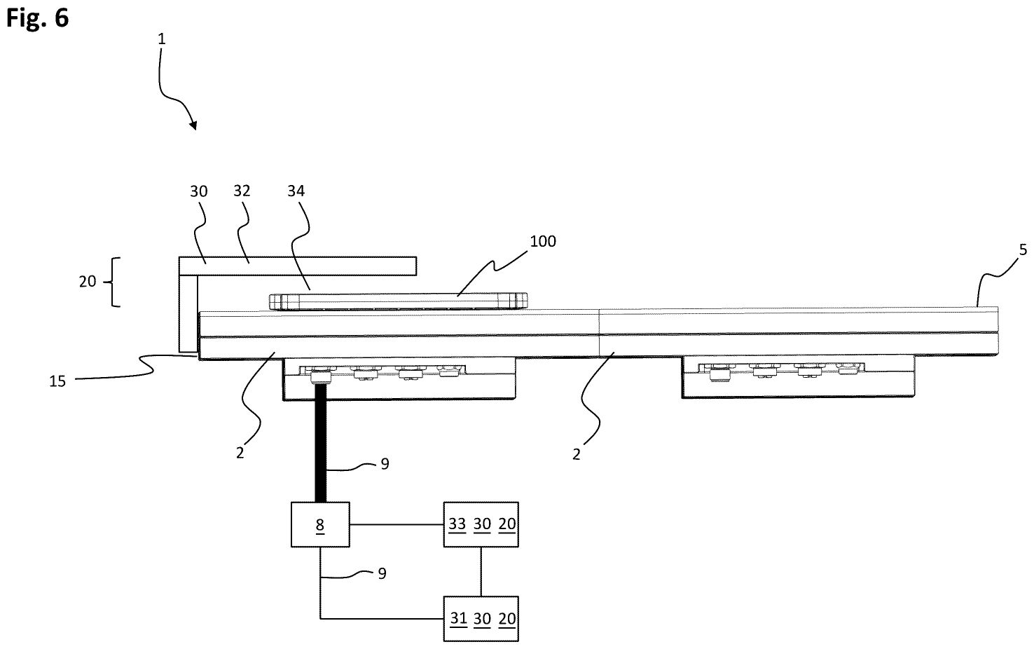

FIG. 6 shows a side view of a planar drive system 1, which also comprises a safety system 20. In this context, the planar drive system 1 comprises an installation position in which the stator surface 5 is not horizontal but vertical. The safety system 20 shown in FIG. 6 may also be used for other non-horizontal installation positions. The safety system 20 comprises an active safety device 30. The active safety device 30 comprises an uninterrupted current supply 31, a retaining element 32 and a controller 33. The retaining element is embodied as an emergency stop pocket. If a current failure occurs or, for example, an emergency stop switch of the planar drive system 1 is actuated, the planar drive system 1 of FIG. 6 is set up to first guide the rotor 100 to the retaining element 32 in such a way that the rotor 100 is restricted in its ability to move by the retaining element 32. In the present embodiment example, this is achieved by moving the rotor 100 into the emergency stop pocket 34. The rotor 100 is also held in the emergency stop pocket 34 when a current supply to the stator modules 2 is switched off and there is therefore no longer any interaction between the rotor magnetic field and the stator magnetic field.

The uninterrupted current supply 31 may be used to provide current to the coil groups 4 for a predetermined period of time in the event that a supply of current fails, so that all rotors 100 may be guided to corresponding retaining devices 32. If the rotors are in the retaining devices 32, the second operating state is present. The controller 33 may be set up to evaluate operating parameters relevant for operational safety, such as an operating voltage applied to the planar drive system controller 8, and to transfer the planar drive system 1 to the second operating state if an evaluation of the relevant operating parameters indicates that unsafe operation could be present, for example due to a lack of or insufficient operating voltage.

In FIG. 6, the controller 33 is shown outside of the planar drive system controller 8. However, the controller 33 may also be integrated into the planar drive system controller 8.

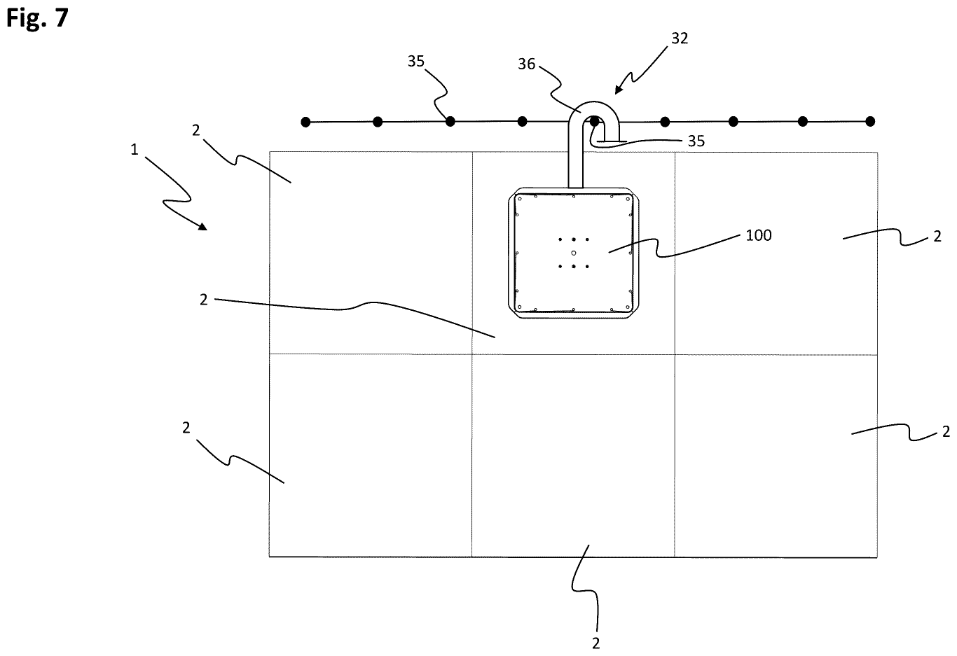

FIG. 7 shows a planar drive system 1 which corresponds to the planar drive system 1 of FIG. 6, in particular with regard to the active safety device 30, unless differences are described in the following. The retaining element 32 does not have an emergency stop pocket 34, but a pin 35, which is arranged above the stator modules 2, and a hook 36, which is arranged on the rotor 100. In order to restrict the movement of the rotor 100, the hook 36 may be guided to the pin 35 in such a way that the rotor 100 hangs at the pin 35 with the hook 36 and then the rotor 100 may no longer fall down even if the current supply to the coil groups fails. Again, this may be controlled with the aid of the uninterrupted current supply 31 and the controller 33 as shown in FIG. 6. In order to ensure the greatest possible flexibility and, in particular, the shortest possible travel distance from the position of the rotor 100 to a pin 35 from each position of the rotor 100, a plurality of pins 35 are arranged above the stator modules 2 at specific distances with regard to one another. The distance between the individual pins 35 must be dimensioned in such a way that the hook 36 may always move unhindered two pins 35 in an uninhibited manner.

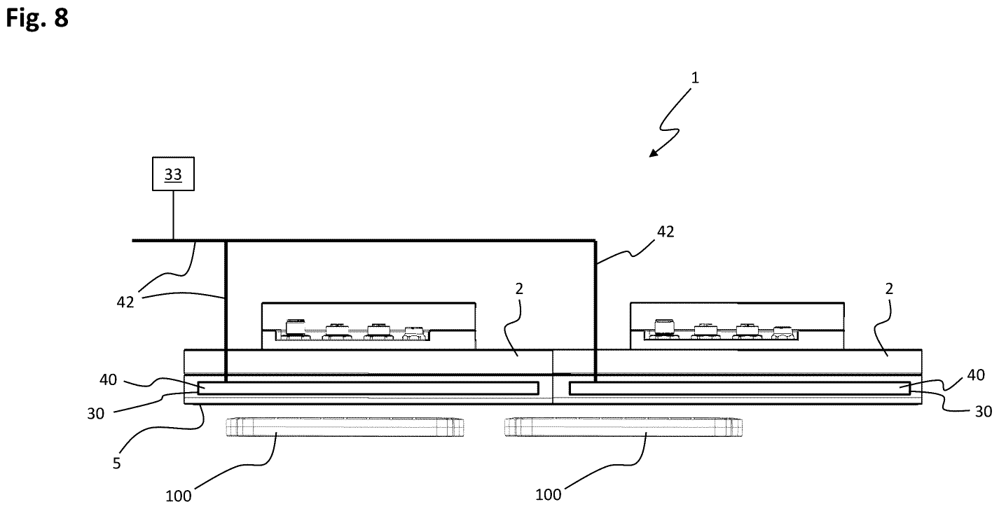

FIG. 8 shows a side view of a planar drive system 1, in which the active safety device 30 comprises a fluid chamber 40 arranged below the stator surface 5. Below the stator surface 5 in this context means that the rotor 100 and the fluid chamber 40 are arranged on different sides of the stator surface 5. The planar drive system 1 comprises an installation position in which the stator surface 5 is arranged horizontally, but the rotors 100 are arranged below the stator surface 5 in relation to the earth's center. The fluid chamber 40 is connected to a supply and discharge line 42, with the aid of which a ferrofluid 41 may be conveyed from a storage container into the fluid chamber 40.

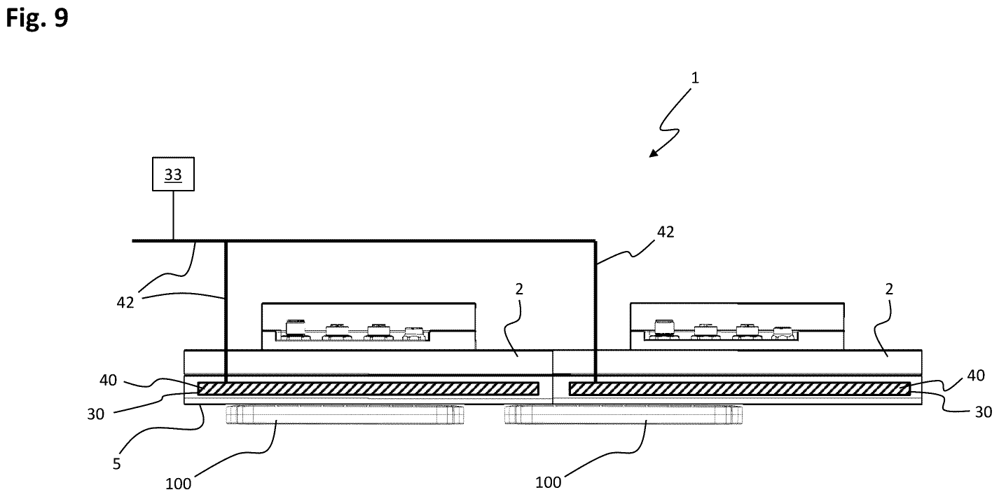

FIG. 9 shows the planar drive system 1 of FIG. 8 after the fluid chamber 40 has been filled with a ferrofluid 41. By filling the fluid chamber 40 with the ferrofluid 41, the rotor 100 is restricted in its ability to move in parallel and perpendicularly with regard to the stator surface 5 due to a magnetic interaction of the ferrofluid 41 with the magnet assemblies 105. The rotors 100 are attracted to the stator surface 5 and remain there, as a magnetic force between the ferrofluid 41 and the magnet assemblies 105 is sufficient for this.

As a result, in FIG. 8, the planar drive system 1 is in the first operating state, in FIG. 9 in the second operating state. If the planar drive system 1 is to be transferred from the second to the first operating state, the ferrofluid 41 may be removed from the fluid chamber 40 again via the inlet and outlet 42. The filling and emptying of the fluid chamber 40 with the ferrofluid 41 may in turn be controlled by a controller 33.

In contrast to the illustration in FIGS. 8 and 9, the planar drive system 1 may also be arranged in such a way that the rotors 100 are arranged above the stator surface 5. This may, for example, serve to protect against removal if the ferrofluid 41 remains in the fluid chamber 40 when the planar drive system 1 is switched off. Furthermore, this may also serve to quickly immobilize the rotor 100 on the stator surface 5 in the event of a current supply failure.

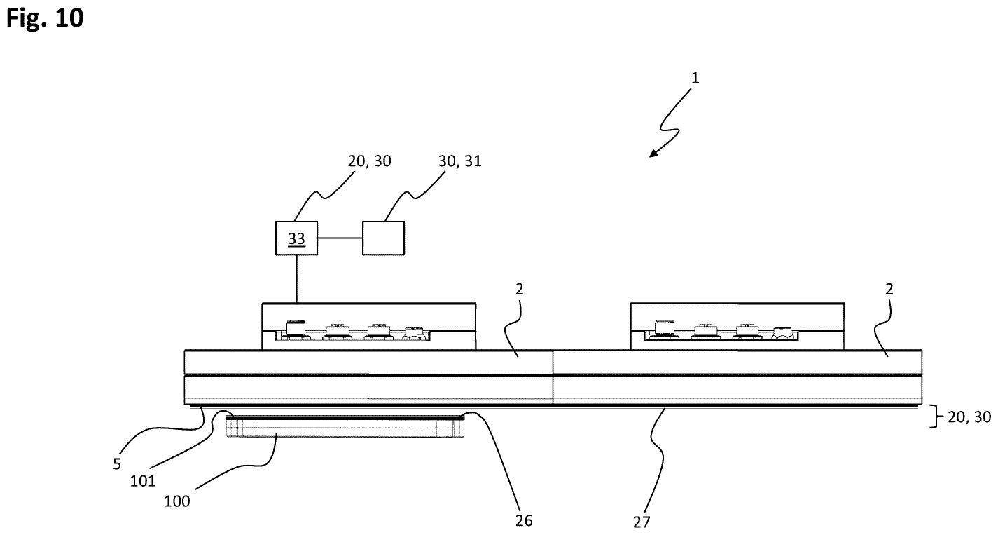

FIG. 10 shows a side view of a planar drive system 1 in which the active safety device 30 comprises a controller 33, an uninterrupted current supply 31 and a first strip 26 and a second strip 27. The planar drive system 1 comprises an installation position in which the stator surface 5 is arranged horizontally, but the rotor 100 is arranged below the stator surface 5 in relation to the earth's center. The first strip 26 is arranged on the rotor 100, the second strip 27 on the stator surface 5. If a current fails, this may cause the rotor 100 to fall downwards. This may be recognized by the controller 33, wherein the controller 33 may be set up to evaluate operating parameters relevant for operational safety, such as a supply voltage, and to transfer the planar drive system 1 to the second operating state if an evaluation of the relevant operating parameters shows that the situation was unsafe to operate. This is carried out in such a way that the coil groups 4 are energized so as to move the rotor 100 towards the stator surface 5 and a fastening 25 analogous to FIG. 3 is formed between the first strip 26 and the second strip 27, which may prevent the rotor 100 from falling down. The fastening 25 therefore at least makes it more difficult for the rotor 100 to move in parallel and perpendicularly with regard to the stator surface 5. The methods described in connection with FIG. 3 may also be used to release the fastening 25.

It may be provided that the first strip 26 comprises a hook tape and the second strip 27 comprises a loop tape. Furthermore, the first strip 26 may also comprise a loop tape and the second strip 27 a hook tape. Furthermore, a velour tape for the first strip 26 or the second strip 27 is also possible instead of the fleece tape. Alternatively, the hook tape may be replaced by a mushroom tape. In an embodiment, both the first strip 26 and the second strip 27 comprise a mushroom tape. In particular, the first strip 26 may be arranged over a large area on the underside 101 of the rotor 100 and cover a large part (more than 75 percent) of the underside 101 or the entire underside 101. The second strip 27 may in particular be arranged over a large area on the stator surface 5 and cover a large part (more than 75 percent) of the stator surface 5 or the entire stator surface 5.

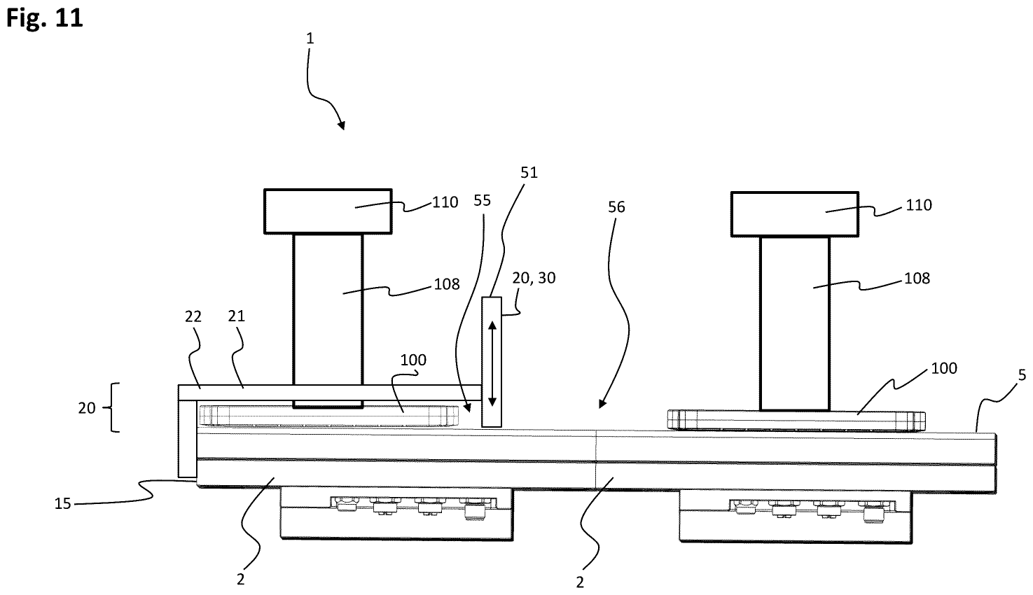

FIG. 11 shows a side view of a planar drive system 1 in which an active safety device 30 comprises a first movable barrier 51 between a first region 55 of the stator surface 5 and a second region 56 of the stator surface 5. The rotor 100 may no longer be moved from the first region 55 to the second region 56 after the first movable barrier 51 is closed. This may serve the purpose of safety if an object 110 arranged on an object holder 108 of the rotor 100 is to be removed. Furthermore, due to the first movable barrier 51, further rotors 100 may no longer move from the second region 56 into the first region 55, so that a hazard from further rotors 100 during a loading or unloading process may be reduced.

For this purpose, it may be provided, as shown in FIG. 11, that the passive safety device 21 described in connection with FIGS. 1 and 2 is also arranged with the double rails 22 in the first region 55. In this way, further securing may be achieved. Furthermore, it may be provided that the first movable barrier 51 is controlled by a controller 33. In addition, it may be provided that, after the rotor 100 has entered the first region 55 and the first movable barrier 51 has closed, the drive coils 4 in the first region 55 are de-energized and the rotor 100 is thus placed on the stator surface 5. In this way, unintentional movement of the rotor 100 during removal of the object may be avoided.

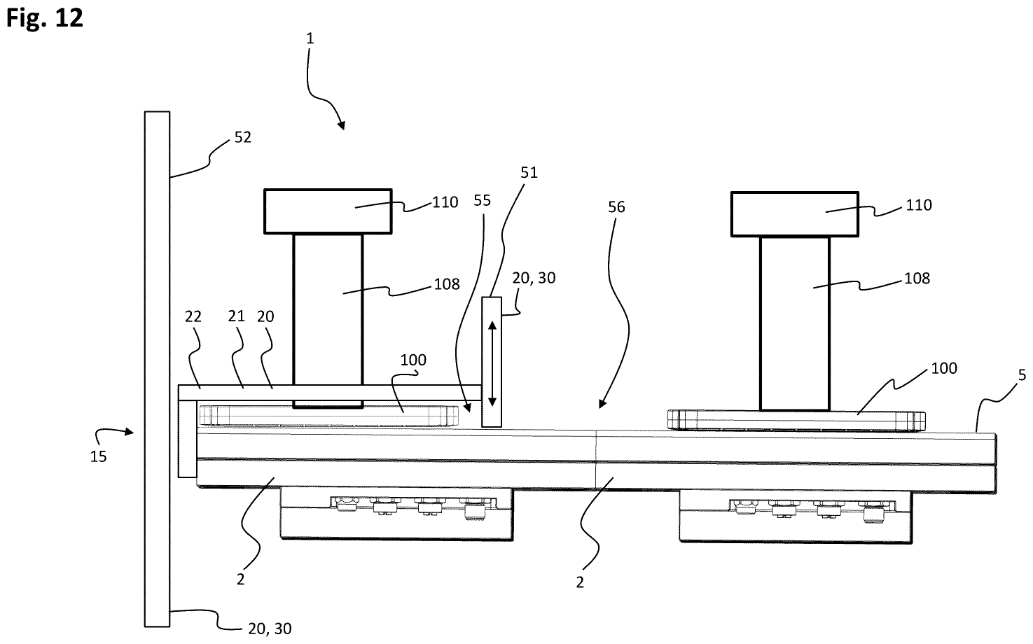

FIG. 12 shows a side view of a planar drive system 1 corresponding to the planar drive system 1 of FIG. 11, unless differences are described in the following. The active safety device 30 additionally comprises a second movable barrier 52 between the first region 55 and an edge 15 of the planar drive system 1. The second movable barrier 52 may only be opened when the first movable barrier 51 is closed. This may be controlled, for example, with the aid of the controller 33. It may also be provided that the second movable barrier 52 may only be opened when the drive coils 4 of the stator assemblies 3 are de-energized in the first region 55. The second movable barrier 52 may also be referred to as a safety door. The second movable barrier 52 protects an operator of the planar drive system 1 when loading the rotor 100 with an object 110 or when removing the object 110, since uncontrolled movements of the rotor 100 may be avoided.

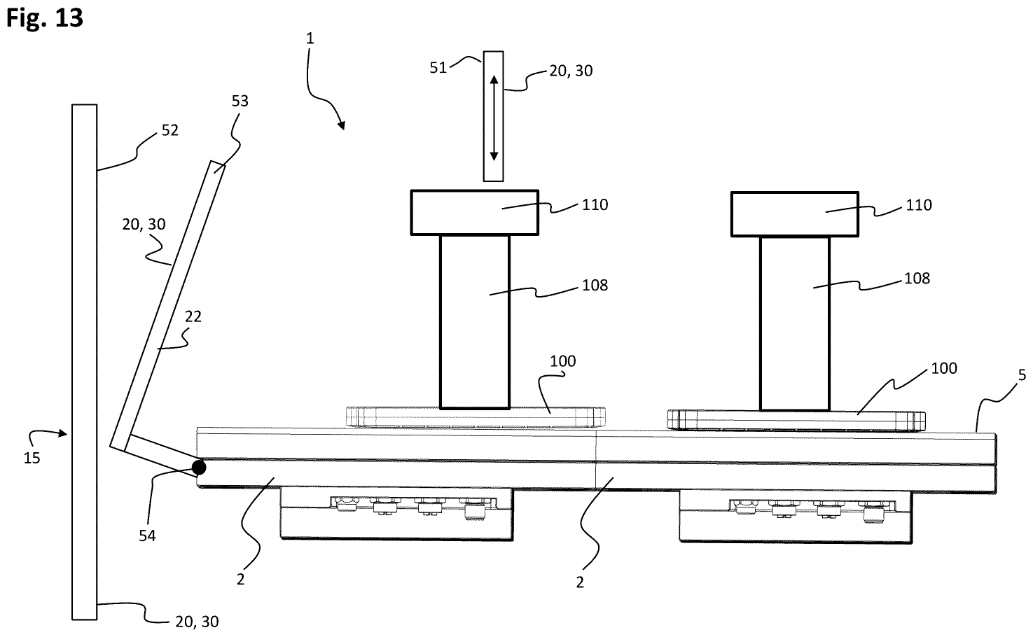

FIG. 13 shows a side view of a planar drive system 1 that corresponds to the planar drive system 1 of FIG. 12, unless differences are described in the following. In this embodiment example, the double rail 22 is not part of a passive safety device 21, but is also part of the active safety device 30 and is embodied as a third movable barrier 53. The third movable barrier 53 is rotatably mounted at a pivot point 54. In FIG. 13, the third movable barrier 53 is shown in an open position. If a rotor is now moved in the direction of the edge 15 of the planar drive system 1, the first movable barrier 51 and the third movable barrier 53 may subsequently be closed.

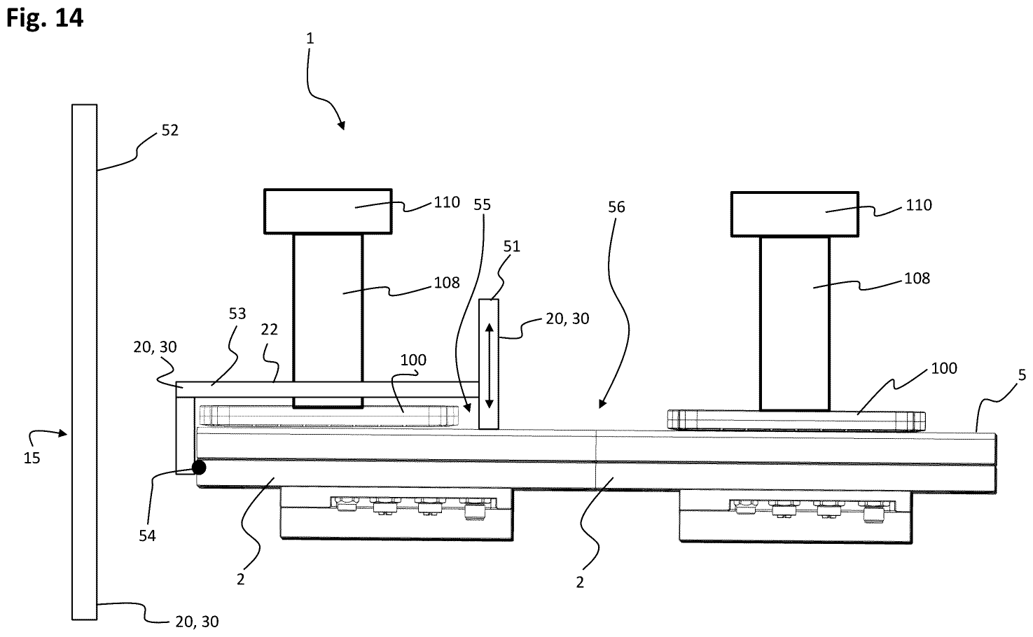

FIG. 14 shows a side view of the planar drive system 1 from FIG. 13 after the rotor has been moved towards the edge 15 of the planar drive system 1 and the first movable barrier 51 and the third movable barrier 53 have been closed. Now the second movable barrier 52 may be opened and, as the case may be, the drive coils 4 of the stator assemblies 3 may be de-energized in the first region 55. In the embodiment example of FIGS. 13 and 14, there are no permanently installed double rails 22 as part of a passive safety device 21, so that when the second movable barrier 52 is closed, the entire stator surface 5 is available for movements of the rotors 100. This allows for a more flexible use of the planar drive system.

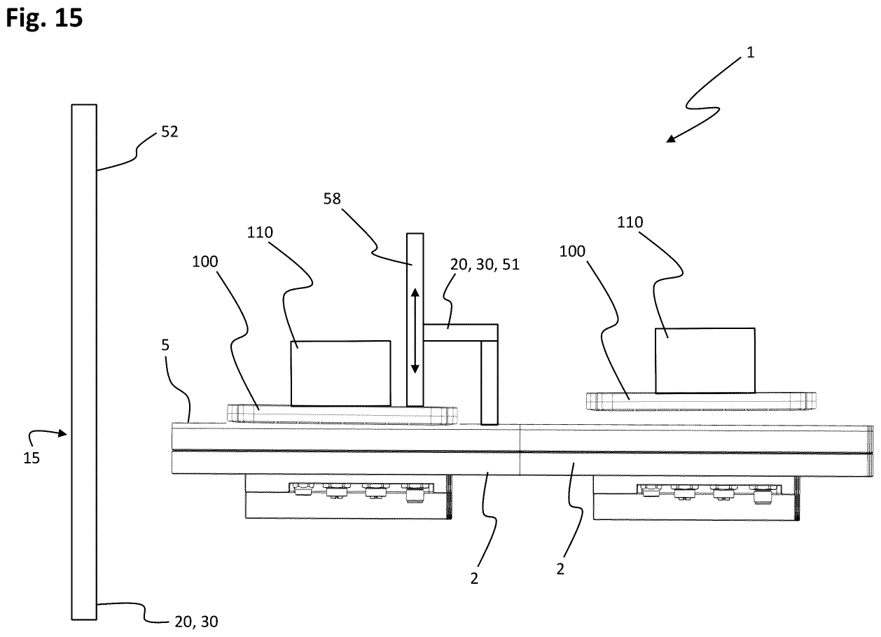

FIG. 15 shows a side view of a planar drive system 1 which corresponds to the planar drive system 1 of FIG. 12, unless differences are described in the following. The first movable barrier 51 comprises a hold-down device 58. When the first movable barrier 51 is closed, the hold-down device 58 fixes the rotor 100 on the stator surface 5. This allows for the rotor 100 to be at least restricted in terms of its movability in parallel and perpendicularly with regard to the stator surface 5 at the same time as the first movable barrier 51 is closed. The second movable barrier 52 shown in FIG. 15 may also be omitted, as the case may be, but otherwise serves the function already described in connection with FIG. 12.

The hold-down device 58 means that an object holder 108 may be omitted and the object 110 may be arranged directly on the rotor 100. Furthermore, in this embodiment example, it is possible to use the entire stator surface 5 for movements of the rotor 100 when the first movable barrier 51 is open.

The hold-down device 58 may also be provided independently of the first movable barrier 51. In particular, the hold-down device 58 may engage in bores of the rotor 100 and thus achieve additional fixation of the rotor 100 in the first direction 11 or the second direction 12.

The first movable barrier 51 described in connection with FIGS. 11 to 15 may be embodied in such a way that the first region 55 is completely sealed off from the second region 56 of the stator surface 5.

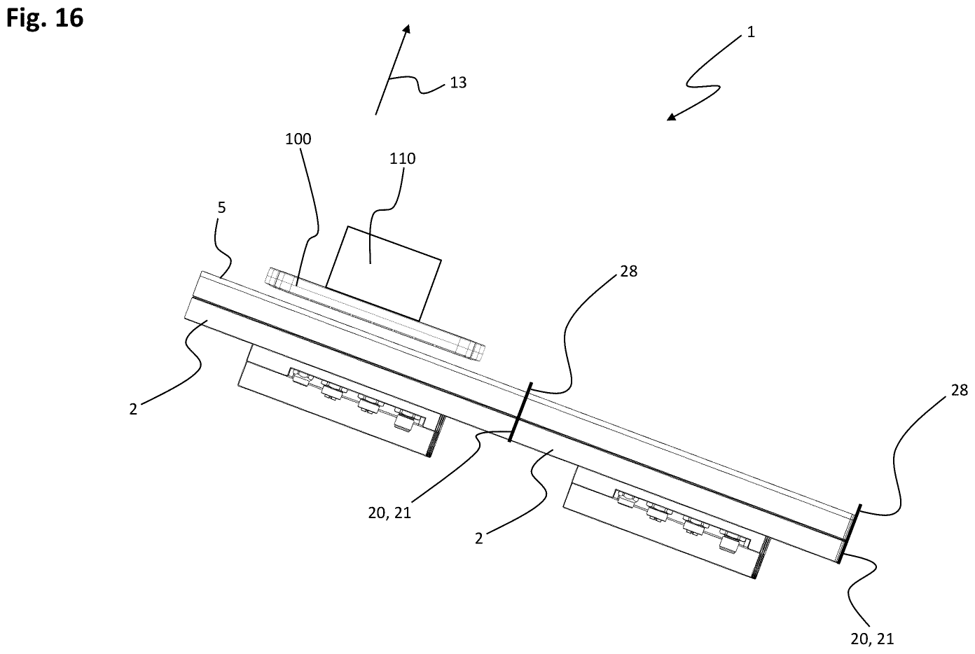

FIG. 16 shows a side view of a planar drive system 1 in which a safety system 20 is also provided in the form of a passive safety device 21. Two stator modules 2 are shown, wherein the stator modules 2 are arranged in such a way that the stator surface 5 is not arranged horizontally, but at an angle. A rotor 100 is arranged above one of the stator modules 2. A retaining plate 28 is arranged between the stator modules 2 which projects beyond the stator surface 5, for example by at least one millimeter and at most two millimeters, for example by one and a half millimeters. If the electrical supply for the entire planar drive system 1 or for the two stator modules 2 were to fail, the rotor 100 could possibly slide down along the stator surface 5 and pose a danger to an operator or a transported object 110. However, the rotor 100 is restricted in its mobility by the retaining plate 28, so that the rotor 100 cannot slide off the stator surface 5. In particular, it may be provided that all stator modules 2 comprise a corresponding retaining plate 28, especially on the lower side of the stator module in terms of gravity. This is also shown in FIG. 16.

In the second operating state, the rotor 100 is thus held at the stator surface 5 with the aid of one of the retaining plates 28. In order to release the rotor 100 from the stator surface 5 again when it is again possible to energize the coil groups 4, it may be provided that the coil groups 4 are energized in such a way that the rotor 100 is now raised again in such a way that a distance of the rotor 100 from the stator surface 5 is greater than the dimension by which the retaining plate 28 projects beyond the stator surface 5. The number of stator modules 2 may of course be larger than two.

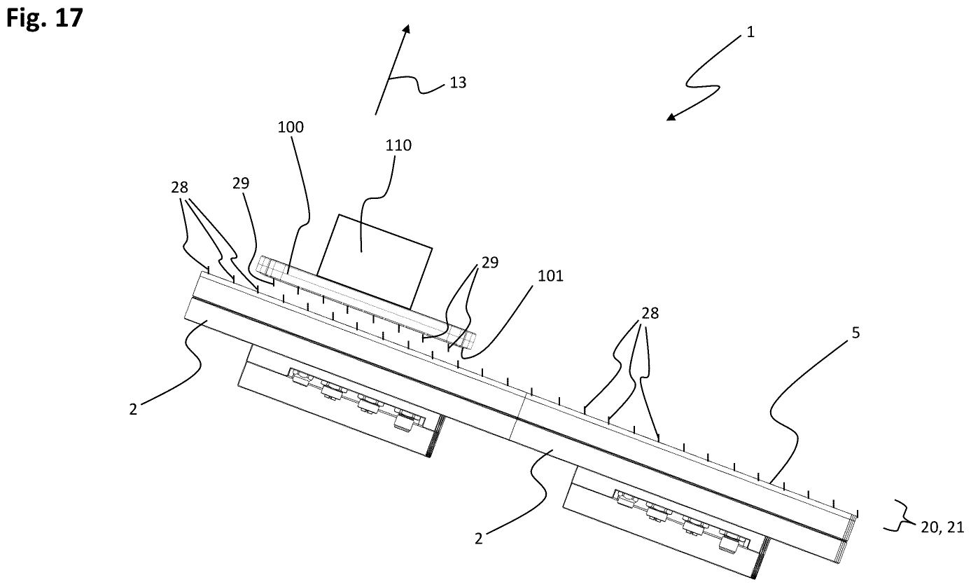

FIG. 17 shows a side view of a planar drive system 1 which corresponds to the planar drive system 1 of FIG. 16, unless differences are described in the following. The planar drive system 1 comprises two stator modules 2 and a rotor 100. The safety system 20 in the form of a passive safety device 21 comprises a plurality of retaining plates 28 at the stator surface 5, which project beyond the stator surface 5, for example by at least 1 millimeter and at most 2 millimeters, for example by 1.5 millimeters. The retaining plates 28 are arranged in parallel to gravity and thus at an angle to the stator surface 5. On its underside 101, which is aligned with the stator surface, the rotor 100 comprises further retaining plates 29 which are aligned in parallel with regard to the retaining plates 28. If the electrical supply for the entire planar drive system 1 or for the two stator modules 2 was to fail, the rotor 100 could possibly slide down along the stator surface 5 and pose a danger to an operator or a transported object 110. However, the retaining plates 28 and further retaining plates 29 interlock with one another, so that the rotor 100 is restricted in its mobility in such a way that the rotor 100 cannot slide off the stator surface 5.

In the second operating state, the rotor 100 is thus held on the stator surface 5 with the aid of the retaining plates 28 and the further retaining plates 29. In order to release the rotor 100 from the stator surface 5 again when the coil groups 4 may be energized again, it may be provided that the coil groups 4 are energized in such a way that the rotor 100 is now raised again in such a way that a distance of the rotor 100 from the stator surface 5 is larger than the dimension by which the retaining plates 28 project beyond the stator surface 5 and the further retaining plates 29 project beyond the underside 101 of the rotor 100. A distance is thus embodied in the third direction 13 between the retaining plates 28 and the other retaining plates 29, so that the rotor 100 may be moved unhindered above the stator modules.

The distances between the individual retaining plates 28 and the distances between the other retaining plates 29 may be matched to one another and may be between five and fifteen millimeters, in particular ten millimeters. If the current supply to the coil groups 4 fails, the rotor 100 may slide downwards by a maximum of fifteen millimeters until it is stopped by the interlocking of the retaining plates 28 and the other retaining plates 29. Of course, the planar drive system 1 may be extended by further stator modules 2 with retaining plates 28.

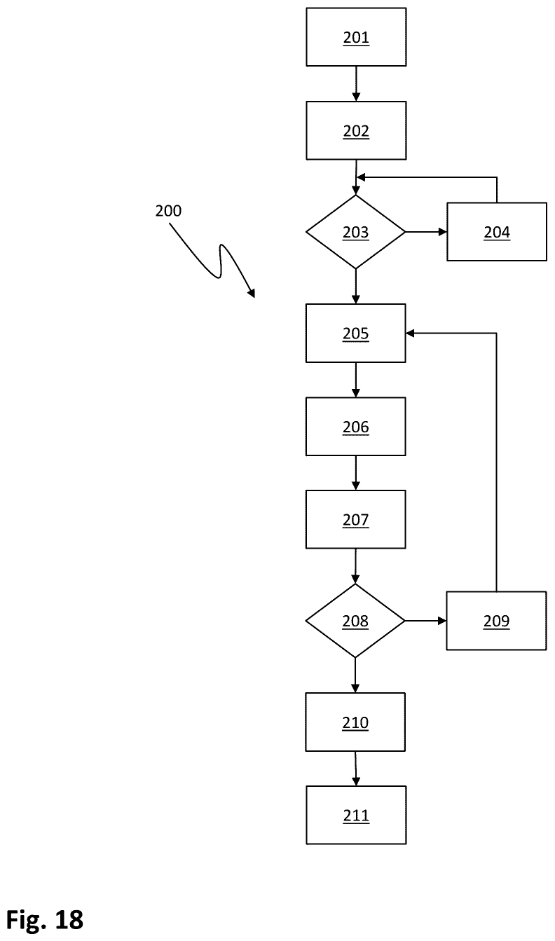

FIG. 18 shows a flow chart 200 of an operating method of a planar drive system 1, which may correspond to the planar drive system 1 of FIGS. 11 to 15. In a first method step 201, loading and/or unloading of a rotor 100 is requested. This may take place, for example, with the aid of a command transmitted to the planar drive system controller 8 by an operator or an automation system in which the planar drive system 1 is used.

In a second method step 202, control commands are issued by the planar drive system controller 8, according to which the coil groups 4 are energized in such a way that the rotor 100 moves to the loading or unloading position. This may be arranged in the first region 55 in each case.

In a third method step 203, the planar drive system controller 8 checks whether the rotor 100 is in the loading or unloading position. This may be done, for example, by reading the magnetic field sensors 6.

If the rotor 100 is not yet in the loading or unloading position, control commands are issued by the planar drive system controller 8 in a fourth method step 204, according to which the coil groups 4 are energized in such a way that the rotor 100 moves to the loading or unloading position and the third method step 203 is then carried out again. The fourth method step 204 and the third method step 203 may be carried out several times until the rotor 100 has reached the loading or unloading position.

A fifth method step 205 now follows, in which control commands are issued by the planar drive system controller 8, according to which the coil groups 4 are energized in such a way that the rotor 100 is set down on the stator surface 5. A sixth method step 206 now takes place, in which control commands are issued by the controller 33, after which the first movable barrier 51 closes.

This is followed by a seventh method step 207, in which control commands are issued by the controller 33, after which the hold-down device 58 moves onto the rotor 100. If the hold-down device 58 and the first movable barrier 51 are in one piece, as shown in FIG. 15, the sixth method step 206 and the seventh method step 207 may be carried out simultaneously or only the sixth method step 206 or the seventh method step 207 may be carried out.

In an eighth method step 208, the controller 33 checks whether the first movable barrier 51 and/or the hold-down device 58 and the rotor 100 are in a predetermined position. If this is not the case, the ninth method step 209 takes place, in which the controller 33 issues control commands according to which the first movable barrier 51 and/or the hold-down device 58 are moved upwards again and then, as the case may be, the planar drive system controller 8 issues control commands according to which the rotor is repositioned.

The fifth method step 205, the sixth method step 206, the seventh method step 207 and the eighth method step 208 are then run through again. If it is determined, possibly after running through the fifth to seventh method steps 205, 206, 207 several times in the eighth method step 208, that the first movable barrier 51 and/or the hold-down device 58 and the rotor 100 are in a predetermined position, the tenth method step 210 follows, in which the planar drive system controller 8 issues control commands according to which the coil groups 4 in the first region 55 are de-energized, in particular safely de-energized.

In this context, safely de-energized may mean that it is ensured that the coil groups 4 are not energized. The eleventh method step 211 now takes place, in which the controller 33 issues control commands according to which the second movable barrier 52 is opened.

In the embodiment example of FIGS. 13 and 14, the third movable barrier 53 may alternatively be controlled in the seventh method step and the position of the third movable barrier 53 may be checked in the eighth method step 208 instead of the position of the hold-down device 58. In the ninth method step 209, the third movable barrier 53 is then opened again.

If, as shown in the embodiment examples of FIGS. 11 and 12, individual components such as the third movable barrier 53 or the hold-down device 58 are not present, the method steps associated with these components may also be omitted.

The controller 33 and the planar drive system controller 8 may mutually exchange control commands and/or status information. Furthermore, it may be provided that the controller 33 and the planar drive system controller 8 form a common controller which carries out all the method steps.

The passive safety devices 21 and active safety devices 30 described in the figures may be combined with one another. For example, the movable barriers 51, 52 of FIGS. 11 to 15 may be combined with the double rail 22 of FIGS. 4 and 5. It is also possible to combine the movable barriers 51, 52 of FIGS. 11 to 15 with the active safety devices 30 of FIGS. 8 to 10. The passive safety device 21 of FIG. 3 may be combined with the passive safety device 21 of FIGS. 1 and 2 and with the active safety devices 30 of FIGS. 11 to 15.

TABLE 1
List of reference numerals

```
  1 Planar drive system
  2 Stator module
  3 Stator assembly
  4 Coil group
  5 Stator surface
  6 Magnetic field sensor
  7 Stator module housing
  8 Planar drive system controller
  9 Data line
  11 First direction
  12 Second direction
  13 Third direction
  15 Edge
  20 Safety system
  21 Passive safety device
  22 Double rail
  23 Intermediate space
  25 Fastening
  26 First strip
  27 Second strip
  28 Retaining plate
  29 Further retaining plate
  30 Active safety device
  31 Uninterrupted current supply
  32 Retaining element
  33 Controller
  34 Emergency stop pocket
  35 Pin
  36 Hook
  40 Fluid compartment
  41 Ferrofluid
  42 Inlet and outlet
  51 First movable barrier
  52 Second movable barrier
  53 Third movable barrier
  54 Pivot point
  55 First region
  56 Second region
  58 Hold-down device
100 Rotor
101 Underside
105 Magnetic assembly
108 Object holder
110 Object
200 Flow chart
201 First method step
202 Second method step
203 Third method step
204 Fourth method step
205 Fifth method step
206 Sixth method step
207 Seventh method step
208 Eighth method step
209 Ninth method step
210 Tenth method step
211 Eleventh method step
```

1. A planar drive system, comprising:
at least one stator assembly, each stator assembly having a plurality of coil groups configured for generating a stator magnetic field,
a stator surface above the stator assembly, and
a rotor, wherein the rotor comprises a plurality of magnet assemblies for generating a rotor magnetic field;
wherein, in a first operating state, the rotor is movable above the stator surface in parallel with regard to the stator surface with the aid of an interaction of the stator magnetic field with the rotor magnetic field,
wherein, in a second operating state, the rotor is at least restricted in terms of its movability in parallel with regard to the stator surface by a safety system, and
wherein, in the second operating state, the rotor is also at least restricted in terms of its movability perpendicularly with regard to the stator surface by the safety system.

2. The planar drive system according to claim 1, wherein the safety system comprises an active safety device, wherein the active safety device restricts the rotor in its movability.

3. The planar drive system according to claim 2, wherein the active safety device comprises a first movable barrier between a first region of the stator surface and a second region of the stator surface, wherein the rotor is no longer movable from the first region to the second region after the first movable barrier is closed.

4. The planar drive system according to claim 3, wherein the active safety device comprises a second movable barrier between the first region and an edge of the planar drive system, wherein the second movable barrier is only openable when the first movable barrier is closed.

5. The planar drive system according to claim 4, wherein the second movable barrier is only openable when a current supply to the coil groups of the stator assemblies in the first region is switched off.

6. The planar drive system according to claim 3, wherein the first movable barrier comprises a hold-down device, wherein when the first movable barrier is closed, the hold-down device fixes the rotor on the stator surface.

7. The planar drive system according to claim 2, wherein the active safety device comprises a controller, wherein the controller is configured to evaluate operating parameters relevant for operational safety and to transfer the planar drive system to the second operating state if evaluation of the operating parameters shows that unsafe operation could be present.

8. The planar drive system according to claim 2, wherein the active safety device comprises an uninterrupted current supply.

9. The planar drive system according to claim 2, wherein the active safety device comprises a retaining element, wherein the rotor is guided to the retaining element in the second operating state in such a way that the rotor is restricted in its movability by the retaining element.

10. The planar drive system according to claim 2, wherein the active safety device comprises a third movable barrier with a double rail.

11. The planar drive system according to claim 9, wherein:
the active safety device comprises a fluid compartment arranged below the stator surface; and
wherein the fluid compartment is fillable with a ferrofluid, wherein the rotor is configured to be restricted with respect to its movability in parallel and perpendicularly with regard to the stator surface when the fluid compartment is filled with the ferrofluid, due to a magnetic interaction of the ferrofluid with the magnet assemblies.

12. The planar drive system according to claim 2, further comprising a controller configured to control the active safety device.

13. The planar drive system according to claim 1, wherein the safety system comprises a passive safety device, wherein the passive safety device restricts the rotor in its movability.

14. The planar drive system according to claim 13, wherein the passive safety device is configured to impede energization of the coil groups in the event that a current supply to the coil groups fails and removal of the rotor from the stator surface results.

15. The planar drive system according to claim 13, wherein the passive safety device comprises a fastening.

16. The planar drive system according to claim 15, wherein the fastening comprises a first strip arranged on the rotor and a second strip arranged on the stator surface.

17. The planar drive system according to claim 13, wherein the passive safety device comprises a double rail arranged above the stator surface.

18. The planar drive system according to claim 17, wherein the planar drive system is configured such that in the event that a current supply to the coil groups fails the rotor moves away from the stator surface due to gravity, wherein the rotor is configured to be caught with the aid of the double rail.

19. The planar drive system according to claim 1, wherein:
a planar drive system controller is arranged to control current supply to the coil groups of the stator assemblies and to detect that the planar drive system is in the second operating state;
wherein the planar drive system controller is further arranged to carry out current supply to the coil groups of the stator assemblies such that the planar drive system is transferred from the second operating state to the first operating state.

20. A method for operating a planar drive system according to claim 12, wherein the controller is configured to energize the coil groups of the stator assemblies and/or control the active safety device such that the planar drive system is transferred from the second operating state to the first operating state.
